(19) United States
(12) Patent Application Publication
(10) Pub. No.: US 2025/0056705 A1
(43) Pub. Date: Feb. 13, 2025

(54) Inductively Coupled Plasma Light Source with Switched Power Supply

(71) Applicants: Hamamatsu Photonics K.K., Shizuoka (JP); Energetiq Technology, Inc., Wilmington, MA (US)

(72) Inventors: Frederick Marvin Niell, III, Tampa, FL (US); Donald K. Smith, Newton, MA (US); Matthew M. Besen, Andover, MA (US); Stephen F. Horne, Medford, MA (US); David B. Reisman, Albuquerque, NM (US); Daniel J. Arcaro, Medford, MA (US); Michael J. Roderick, Everett, MA (US)

(73) Assignees: Hamamatsu Photonics K.K., Shizuoka (JP); Energetiq Technology, Inc., Wilmington, MA (US)

(21) Appl. No.: 18/928,527

(22) Filed: Oct. 28, 2024

Related U.S. Application Data
(63) Continuation of application No. 18/077,443, filed on Dec. 8, 2022, now Pat. No. 12,156,322.

(51) Int. Cl. H05H 1/10

(52) U.S. Cl. CPC H05H 1/10

(57) ABSTRACT

A method and apparatus for generating light includes a chamber having a high voltage region, a low voltage region, and a plasma generation region that defines a plasma confinement region. A magnetic core is positioned around the chamber and is configured to generate a plasma in the plasma confinement region. A switched power supply includes a DC power supply and a switched resonant charging circuit that together generate a plurality of voltage pulses at the output causing a plurality of current pulses to be applied to the power delivery section around the magnetic core so that at least one plasma loop is established around the magnetic core that confines plasma in the plasma confinement region, thereby forming a magnetically confined Z-pinch plasma. Light generated by the Z-pinch plasma propagates out of a port in the light source.

The section headings used herein are for organizational purposes only and should not be construed as limiting the subject matter described in the present application in any way.

### INTRODUCTION

Numerous commercial and academic applications have a need for high brightness light in the extreme ultra-violet (EUV) region of the spectrum. For example, EUV light is needed for numerous industrial applications, including metrology, accelerated testing, photoresist, defect inspection, and microscopy. Other applications for EUV light include microscopy, spectroscopy, areal imaging, and blank mask inspection. These and other applications require EUV sources that have high reliability, small physical size, low fixed cost, low operating cost, and low complexity from these important sources of extreme ultraviolet photons.

Known switched power supplies have limited the performance and usefulness of these high brightness light in the extreme ultra-violet (EUV) region of the spectrum because they use magnetic switches which are well known in the art to have numerous performance disadvantages including that they are relatively slow and physically large. New switched power supplies are required to advance the performance of these high brightness EUV light sources.

### SUMMARY

A method and apparatus for generating light includes a chamber having a high voltage region, a low voltage region, and a plasma generation region that defines a plasma confinement region. A gas feed port is positioned proximate to the plasma confinement region and a vacuum pump port is positioned proximate to the plasma confinement region. A magnetic core is positioned around a portion of the chamber and is configured to generate a plasma in the plasma generation region that converges in the plasma confinement region.

A switched power supply is electrically connected between the high voltage region and the low voltage region of the chamber and includes a DC power supply and a switched resonant charging circuit that together generate a plurality of voltage pulses at the output causing a plurality of current pulses to be applied to the power delivery section around the magnetic core so that at least one plasma loop is established around the magnetic core that confines plasma in the plasma confinement region, thereby forming a magnetically confined Z-pinch plasma. In some configurations, the low voltage region is electrically connected to ground potential.

The switched power supply includes a charging switch and a discharging switch that can be a solid-state switch, including for example, metal-oxide-semiconductor field-effect transistors, bi metal-oxide-semiconductor field-effect transistors, insulated-gate bipolar transistors, or similar high voltage semiconductor switches. The switched resonant charging circuit includes at least one inductor and at least one capacitor configured so that the at least one inductor increases a voltage across the at least one capacitor during operation. The switched resonant charging circuit can be configured to increase a DC voltage generated by the DC power supply to less than or equal to twice the DC voltage generated by the DC power supply. The switched resonant charging circuit can be configured to provide enough charging current at the output of the switched power supply to sustain the plasma between generation of the voltage pulses. A flux excluder can be positioned proximate to the magnetic core so that the at least one plasma loop flows between the flux excluder and the magnetic core during operation.

A port is positioned adjacent to the plasma generation region to allow light generated by the Z-pinch plasma to propagate out of the light source.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings described below are for illustration purposes only. The drawings are not necessarily to scale; emphasis is instead generally being placed upon illustrating principles of the teaching. The drawings are not intended to limit the scope of the Applicant's teaching in any way.

FIG. 1 illustrates a cross-section view of a known plasma chamber for generated a Z-pinch ultraviolet light.

FIG. 2 illustrates an ultraviolet light source that includes a solid-state pulsed power supply and power delivery section according to the present teaching.

FIG. 3A illustrates a schematic diagram of a solid-state pulsed power and delivery system for an ultraviolet light source according to the present teaching.

FIG. 3B illustrates a perspective view of a single board solid-state switch subsystem according to the present teaching.

FIG. 3C illustrates an example of a solid-state switch subsystem that includes a six-board power supply configured radially in parallel.

FIG. 4 illustrates plots of current through and voltage across a charging capacitor in a solid-state switch subsystem in a power supply according to the present teaching.

### DESCRIPTION OF VARIOUS EMBODIMENTS

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications, and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the method of the present teaching can be performed in any order and/or simultaneously as long as the teaching remains operable. Furthermore, it should be understood that the apparatus and method of the present teaching can include any number or all of the described embodiments as long as the teaching remains operable.

Extreme ultraviolet (EUV) light sources play an important role in numerous optical measurement and exposure applications. It is desirable that these sources be configured to accommodate numerous use cases. One challenge is to generate high-power and high-brightness EUV light in a configuration with enough flexibility to allows integration with numerous applications and also exhibits high stability and high reliability.

Extreme ultraviolet radiation is referred to in numerous ways by those skilled in the art. Some skilled in the art sometimes referred to extreme ultraviolet radiation as high-energy ultraviolet radiation, which can be abbreviated as XUV. Extreme ultraviolet radiation generally refers to electromagnetic radiation that is part of the electromagnetic spectrum nominally spanning wavelengths from 124 nm to 10 nm. There is some overlap between extreme ultraviolet radiation and what is considered to be the optical spectrum. One particular EUV wavelength of interest is 13.5 nm because that wavelength is commonly used for lithography. Extreme ultraviolet radiation sources, according to the present teaching, are not limited to the generation of EUV radiation. As is known in the art, plasmas can be used to generate a wide spectral range of photons. For example, plasmas generated according to the present teaching can also be used to generate soft x-ray photons (SXR). This includes, for example, photons with wavelengths of less than 10 nm.

So-called Z-pinch plasmas, which have current in the axial direction, have been shown to be effective at producing EUV and SXR light. However, most known sources have employed electrodes to conduct high discharge currents into the plasma. These electrodes, which are typically in contact with high temperature plasma, can melt and produce significant debris, which is highly undesirable as it can greatly reduce the useful lifetime of the source.

Electrodeless approaches to generated EUV are desirable and fill a considerable market need. Such sources are available, for example, from Energetiq, a Hamamatsu Company, located in Wilmington, MA. These sources are based on a Z-pinch plasma, but avoid electrodes entirely by inductively coupling current into the plasma. The plasma in these EUV sources is magnetically confined away from the source walls, minimizing the heat load and reducing debris and providing excellent open-loop spatial stability, and stable repeatable power output. One challenge with known Z-pinch light sources is that their performance, especially in brightness, is limited by their power supplies because they use magnetic switches, which are highly undesirable, and not flexible or easily scaleable.

One feature of the EUV sources of the present teaching is that they are versatile and support various applications with high brightness. In particular, EUV sources of the present teaching improve upon known Z-pinch designs because they can be optimized for peak power and/or for peak brightness as required by the user for a particular application. In addition, EUV sources of the present teaching have a more compact physical foot print and a more flexible component layout.

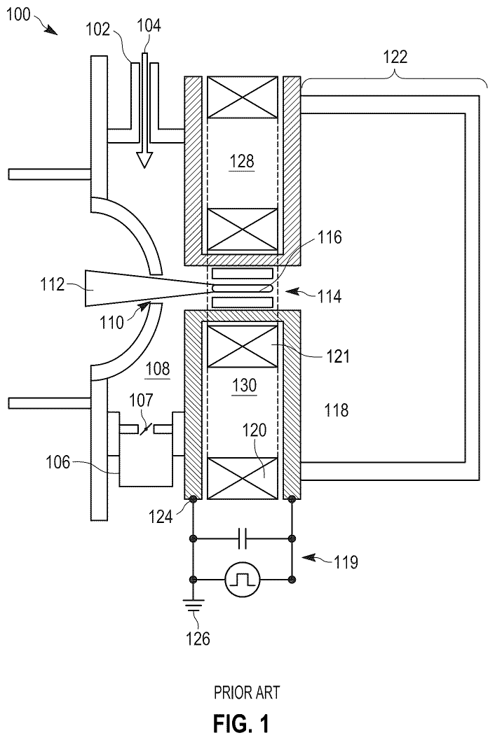

FIG. 1 illustrates a known plasma chamber 100 for generating a Z-pinch ultraviolet light. See, for example, U.S. patent application Ser. No. 17/676,712, entitled “Inductively Coupled Plasma Light Source”, which is assigned the present assignee. The entire contents of U.S. patent application Ser. No. 17/676,712 are incorporated herein by reference.

The chamber 100 includes an interface 102 that passes a feed gas 104 into the chamber 100. A pump 106 is used to evacuate the chamber region 108 to a desired operating pressure and/or to control gas flow in the chamber 100 using a butterfly valve 107 or other means of controlling conductance. A port 110 is provided to pass EUV radiation 112 generated by the EUV plasma.

In various systems, the port 110 is configured to be adaptable for a user to attach to an application system (not shown) where the EUV radiation passes directly through the port 110. A plasma generation region 114 defines a plasma confinement region 116. The plasma confinement region 116 is formed by magnetic induction when a pulse forming and power delivery system 118 provides a current that interacts both actively and passively with magnetic cores 120, 121. A high voltage region 122 is attached to the plasma generation region 114. A low voltage region 124 has an outer surface that is coupled to low voltage potential, which in some embodiments is ground 126 as shown in FIG. 1. A pulsed power supply 119 that uses magnetic switches is electrically coupled to the power delivery system 118. The chamber 100 also includes region 128 between the inner and outer magnetic cores 121, 120 where the current carried by the inductively coupled plasma flows. During operation of the Z-pinch plasma in this known chamber 100, the feed gas in the plasma generating region 114 is compressed by the electric pulses generated by the pulsed power supply 119, followed by an expansion of the gas after the pulse.

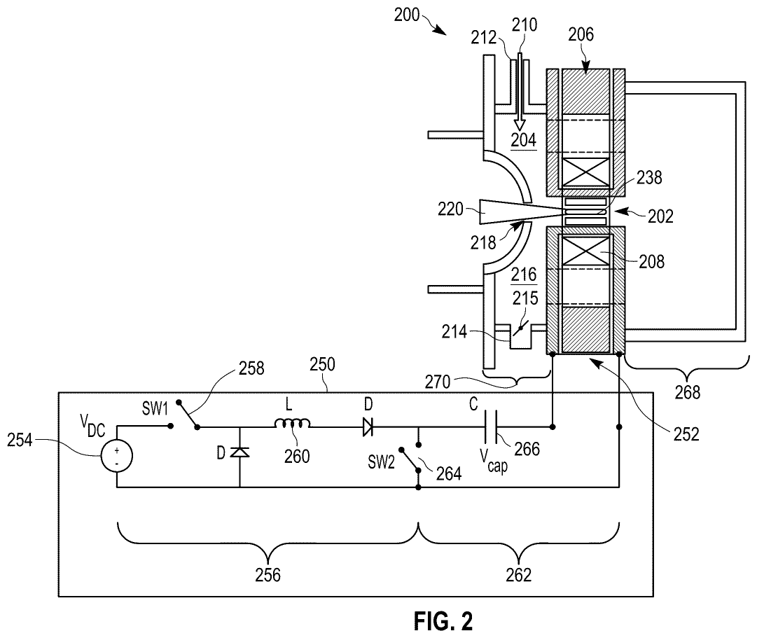

FIG. 2 illustrates an ultraviolet light source 200 that includes a solid-state pulsed power supply 250 and power delivery section 252 according to the present teaching. The source 200 is an inductively coupled design that uses magnetic confinement of the plasma in the plasma confinement region 238 where a Z-pinch is generated away from the components of the chamber 204 to provide high reliability and high stability. A flux excluder 206 is used to increases the confinement of magnetic flux in the power delivery section, thus reducing the inductance. In operation, one or more plasma loops flow through the flux excluder region 206 and through the plasma generation region 202, making a plasma loop around the inner magnetic core 208. The plasma loops themselves do not produce significant EUV light

A target gas 210 enters through an interface 212 into the chamber 204. In some embodiments, the target gas is Xenon. A pump 214 is used to evacuate the chamber region 216 to a desired operating pressure. A valve, such as a butterfly valve 215, is used to control the pressure in the chamber region 216. A transparent port 218 is provided to pass EUV radiation, that is, EUV light 220 generated by the plasma. This port 218 can be, for example, any of the various kinds of ports described in connection with the port 110 of FIG. 1.

A solid-state pulsed power supply (PPS) 250 is used to drive current through the power delivery section 252 to a low voltage region to generate the plasma. In one specific embodiment, the low voltage region is ground. However, it should be understood that the low voltage region is not necessarily at ground potential. The solid-state pulse power supply 250 is connected to the power delivery section 252 at a high voltage side 268 and a low voltage side 270. In some configurations, a diameter of plasma confinement region 238 is smaller than a diameter of a high voltage region electrically coupled to the high voltage side 268. The pulsed power system 250 includes a DC power supply 254 that provides a DC voltage (VDC) at an output. A resonant charging subsystem 256 with a charging switch 258 and an inductor 260 is coupled to the output of the DC power supply 254. The resonant charging subsystem 256 is configured to approximately double the voltage provided by the DC power supply 254 at the capacitor 266. This is accomplished using inductive energy storage with the inductor 260 to effectively double the voltage provided by the DC power supply 254 at the capacitor 266. In other words, the resonant charging subsystem 256 and the capacitor 266 form a resonant charging circuit.

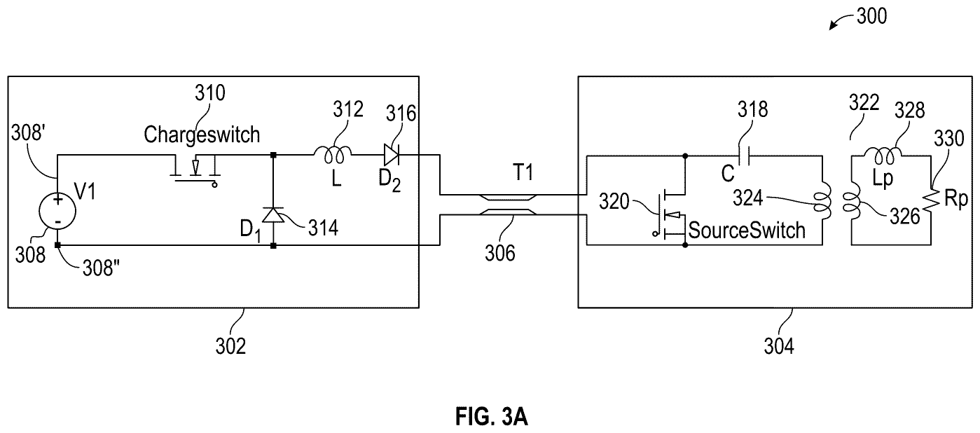

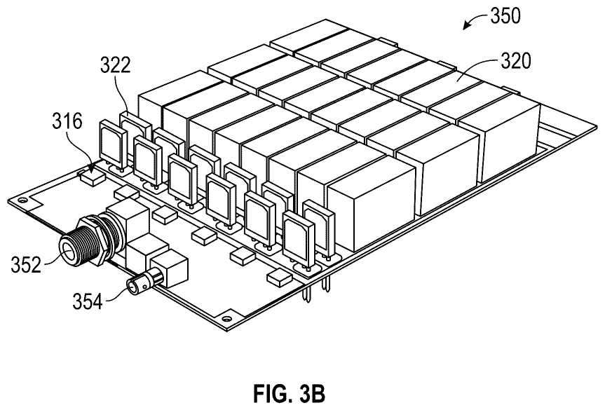

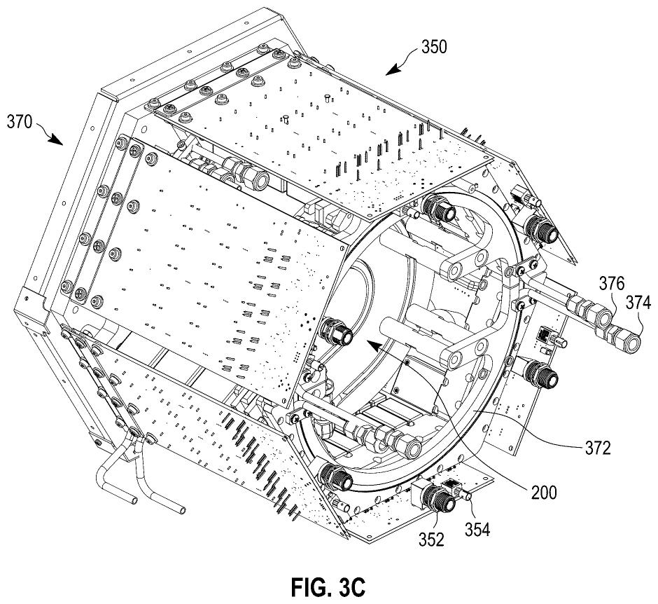

The solid-state pulsed power supply 250 also includes a solid-state switch subsystem 262 that includes a discharge switch 264 and at least one capacitor 266 that generates the current necessary to form a plasma. The at least one capacitor is typically a plurality of capacitors as described in connection with FIG. 3B. FIG. 3A illustrates a schematic diagram of a solid-state pulsed power and delivery system 300 for an ultraviolet light source according to the present teaching. The system 300 includes a resonant charging subsystem 302, a solid-state switch subsystem 304, and a transmission line system 306 coupling the resonant charging subsystem 302 and the solid-state switch subsystem 304. The resonant charging subsystem 302 includes a DC power supply 308 that can be, for example, a 1 kV power supply as one particular embodiment that generates a high voltage in the range of about 500V to 1 kV. Other embodiments can have the DC power supply 308 operating in the several kV range. The DC power supply 308 provides a DC voltage to the charging switch 310, which in many embodiments, includes a high-power solid-state switch that switches the output voltage of the DC power supply 308. In recent years, there have been great advances in the performance of high-power solid-state device technology. For example, Heterojunction Bipolar Transistor (HBT), Insulated Gate Bipolar Transistor (IGBT), Silicon Carbide Metal-Oxide-Semiconductor Field-Effect Transistor (SiCFET), and Bi Metal-Oxide-Semiconductor Field-Effect Transistor (BiMOSFET) are examples of robust high-power and fast-switching solid-state switches that are useful for power supplies according to the present teaching. BiMOSFET devices are particularly useful because they combine the strengths of MOSFET devices with the strengths of IGBT devices to achieve a positive temperature coefficient of V_{ce} (voltage difference between the collector and emitter) and V_{f} (forward voltage). BiMOSFET devices also advantageously feature low conduction losses making them particular suitable for high-frequency and/or high-power density applications.

When the charging switch 310 is closed, the voltage generated by the DC power supply 308 is applied to the inductor 312 that stores energy for the pulses. The inductor 312 is one or more inductors coupled in series that provides a large inductance value. For example, in some systems, the total inductance value of inductor 312 can be on order of 1-10 micro-H or higher in some embodiments.

Diodes D1 314 and D2 316 prevent current passed by the charging switch 310 from reversing and also provide a charging current that pre-ionizes the plasma, thereby sustaining the plasma loop. The resonant charging subsystem 302 is configured to approximately double the voltage provided by the DC power supply at the capacitor 318. We note that the resonant charging subsystem 302, transmission line 306, and capacitor 318 form the resonant charging circuit.

The transmission line system 306 couples the voltage generated by the resonant charging subsystem 302 to the solid-state switch subsystem 304. The solid-state switch subsystem 304 includes a capacitor 318 and a solid-state discharge switch 320. In many embodiments, the capacitor 318 is a bank of multiple parallel-connected capacitors that provides a relatively high capacitance value at comparatively low inductance. For example, in one specific embodiment, the total capacitance value of capacitor 318 can be on order of 3,000 nF. With the specific embodiment described, the peak pre-pulse current is in the range of 380 Amps with a half sine wave charging time of in the 15-20 microsecond range.

The schematic diagram of a solid-state pulsed power and delivery system 300 shows the power delivery section 252 (FIG. 2) as the primary 324 and the plasma as the secondary 326 of the transformer 322. Current pulses generated by the solid-state switch subsystem 304 are applied to a primary 324 of the transformer 322 via the power delivery section 252. The plasma itself is modeled as the secondary 326 of the transformer 322 having both an inductive component 328 and resistive component 330.

Pulsed operation of the solid-state pulsed power and delivery system 302 is accomplished by switching through two solid-state switches, the charging switch 310 in the resonant charging subsystem 302 and the discharging switch 320 in the solid-state switch subsystem 350. The charging switch 310 in the resonant charging subsystem 302 applies high-voltage pulses across the capacitor 318 or capacitor bank in the solid-state switch subsystem 304. When the charging switch 310 is closed, current flows through the resonant charging subsystem 302 and charges the capacitor 318. The diodes D1 314 and D2 316 are configured to ensure the desired direction of current flow and are also configured so that a charging current is provided that pre-ionizes the plasma, thereby sustaining the plasma loop in between pulses. The charging voltage including the maximum charging voltage can be expressed with the below equations.

$${V}_{c} = {V}_{DC} ( 1 − cos ( \frac{t}{\sqrt{LC}} ) )$$

$${V}_{c} = 2 {V}_{D C} at t = π \sqrt{LC}$$

The pre-pulse current is given by the following equation:

$$i = \frac{{V}_{D C}}{\sqrt{\frac{L}{C}}} sin ( \frac{t}{\sqrt{L C}} )$$

The pre-ionization is important because Z-pinch operation requires a sustained plasma loop because continually ionized gas is necessary for proper function. The discharge switch 320 is closed when the maximum voltage across capacitor 318 is reached.

Referring to both FIGS. 2 and 3A, the resulting discharge causes capacitor 318 to drive a current through the high voltage side 268 and the low voltage side 270 of the power delivery section 252. Consequently, the inner magnetic core 208 couples the current pulse to the plasma loops, resulting in a large current pulse in the plasma that forms loops that flow through the flux excluder region 206 and through the plasma confinement region 202, making a loop around the inner magnetic core 208. In some embodiments, at least three inductively coupled plasma loops converge in the plasma confinement region 202 to form a magnetically confined Z-pinch. The plasma confinement region 202 produces and emits nearly 100% of the EUV radiation generated by the plasma. The result is that the source 200 produces high quality EUV light 236 from a well-defined and stable pinch plasma confinement region 202. Importantly, the source 200 is a highly compact source compared with other known sources for generating stable pinch plasma suitable for light source applications. These features are made possible by the solid-state switching power supply of the present teaching.

Another feature of the present teaching is that the solid-state pulsed power system pulse forming and power delivery section 300 can be constructed with the power supply components on multiple circuit boards so that the power supply can be configured in a relatively small area compared with known switching power supply technologies.

FIG. 3B illustrates a perspective view of a single board solid-state switch subsystem 350 according to the present teaching. The solid-state switch subsystem 350 includes banks of capacitors 320 configured in parallel to present a relatively large capacitance. For example, such a solid-state switch subsystem 350 can include, in one particular embodiment suitable for commercial products, 24 capacitors 320 on a single board to present a capacitance of approximately 528 nF. The solid state switches 322 are BiMOSFET switches in this particular embodiment that are integrated on the single board subsystem 350 and configured with diodes that protect components 310, 314, 316, 320, and 322 from voltage reversals as described in connection with FIG. 3A. Referring also to FIG. 3A, the connector 352 that couples the solid-state switch subsystem 350 to the charging cable 306 which couples to the charging subsystem 302 is also included on the subsystem 350. In addition, a fiber coupler 354 is shown for coupling an optical fiber from a controller to the solid-state switch subsystem 350 that is used for high-speed triggering the switches 322.

FIG. 3C illustrates an example of a solid-state switch subsystem 370 that includes a six-board power supply configured radially in parallel with, for example 24 capacitors 320 per board with a total capacitance in the range of 3000 nF, as described in connection with FIG. 3B. Other embodiments can include any number of capacitors 320 per board with a total capacitance in the range of several microfarads. Referring to all of FIGS. 3A, 3B, and 3C, the capacitors 320 are charged with the resonant charging subsystem.

The radial configuration of the solid-state switch subsystem 370 has highly efficient thermal management. In some configurations, a cooling ring 372 that is feed with cooling fluid, such as water, via fluid inlet 374 and fluid outlet 376 is positioned around the circumference of the solid-state switch subsystem 370 to provide temperature control

The radial configuration of the solid-state switch subsystem 370 is also highly compact. In order to make the entire pulsed power source more compact, fiber optical cables can be coupled to the fiber coupler 354 and are used to trigger the discharging switches 322 at peak voltage by triggering the switches 322 as described in connection with FIG. 3B.

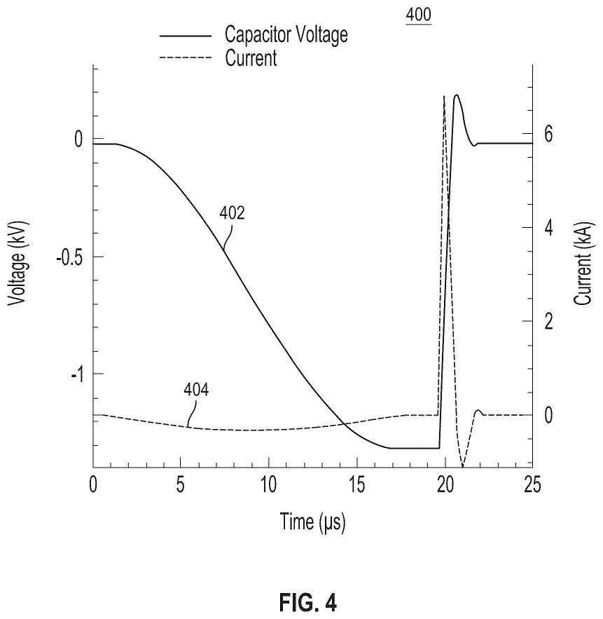

FIG. 4 illustrates plots 400 of current through and voltage across a charging capacitor in a solid-state switch subsystem in a power supply according to the present teaching. The plot 402 represents voltage in Volts across the charging capacitor in the solid-state switch subsystem as a function of time in microseconds. The plot 404 represents current in kAmps flowing through the charging capacitor as a function of time in microseconds. The plots 400 indicate that when the elapsed time reaches about 20 microseconds, a large voltage pulse is established, which can be on order of about 1.3 k KV with an associated peak current pulse of about 6.8 kA.

Thus, one important feature of the present teaching is that since the solid-state charging switch 310 and the solid-state discharging switch 320 do not work on magnetic saturation like known power supplies for generating Z-pinched inductively coupled plasmas, they can be conveniently located inside the power supply unit itself. This allows designers to locate the switching devices next to the capacitors 320 on the switch board itself, which has the advantage that it minimizes inductance. This is possible, at least in part, because the FET switching devices themselves are compact especially when compared with magnetic switches. Such a configuration is not possible in known systems that use coupling core magnetic circuits as simplicity and space requirements make such configurations impractical for a commercial product.

There are many advantages of the solid-state pulsed power system pulse forming and power delivery second according to the present teaching. One advantage is that by using the pulsed power system according to the present teaching to drive and contain the plasma, the plasma source 200 (FIG. 2) operates without the use of electrodes that are commonly used to conduct discharge current to the plasma in known systems.

Another advantage of the solid-state pulsed power system of the present teaching is that the resonant charging with the inductive energy storage and voltage doubling as described herein allows for much higher frequency operation compared with prior art systems. For example, when solid state switching devices are used for switches 310 and 320, a frequency of operation in the range of 10 KHz can be easily achieved, and significantly higher frequency operation is possible. Furthermore, when solid-state switching devices are used, a wide range of pulse energies can be obtained. For example, with commercially available devices, the pulse energy can be in the range of several Joules. Consequently, with the higher frequency of operation and higher pulse energies, much higher brightness can be achieved in a light source using the solid-state pulsed power system of the present teaching.

Yet another advantage of the solid-state pulsed power system of the present teaching is that the power supply can generate a controllable amount of charging current pulses that can be used to produce a pre-ionization current that is sufficient to obtain desired Z-pinching conditions. The solid-state pulsed power systems of the present teaching are highly adjustable to generate a wide range of pre-ionization pulse conditions. Suitable pre-ionization pulses are much smaller than the pulses primarily used generate the plasma. Typically, the pre-pulse will have a maximum current in the sub kiloamp range whereas the main pulse will have a maximum current of 5-10 kA. However, these power systems can generate highly adjustable pulses to provide flexible operation.

Thus, another feature of the power supplies of the present teaching is that these power supplies can generate pulses with highly adjustable dwell time. By dwell time, we mean the delay after the charging time and before the main capacitor discharge. One measure of charging time is the time that the switches 310 in the resonant charging subsystem 302 are closed. In one specific embodiment, the dwell time is controllable from below one 1 to over 50 microseconds in order to provide more desirable and varied operating conditions.

As described herein, pre-ionization is necessary to obtain favorable Z-pinch plasma generation conditions. Also, as described herein, pre-ionization according to the present teaching is accomplished by generating a pre-pulse from current leakage for charging where the amplitude of the pre-pulse is much less than the main pulse that generates the Z-pinched plasma. The dwell time, which is roughly the time between the pre-pulse and the main pulse is chosen to provide the desired Z-pinching conditions.

One skilled in the art will appreciate that there are numerous methods of generating ultraviolet light according to the present teaching. These methods generally provide a feed gas to a plasma confinement region 202 in a plasma chamber 204 (FIG. 2). Some methods also apply a feed gas or a second gas to a port positioned at one or more of various locations. A high voltage pulse is applied to a high voltage region 268 connected to the plasma confinement region 202 in the plasma chamber 204 relative to a low voltage region 270.

A train of voltage pulses are generated by the solid-state pulsed power supply 300 and are applied to at least one capacitor 318 electrically connected across a power delivery section 304 surrounding an inner magnetic core 208 that is positioned around the plasma confinement region 202. The train of voltage pulses cause the at least one capacitor 318 to charge until a voltage maximum is reached and the solid state discharge switch 320 is closed resulting in the at least one capacitor discharging causing the inner magnetic core 208 to couple current pulses into the plasma confinement region 202, thereby forming a plasma in a loop where the plasma is sustained between voltage pulses by a charging current that causes pre-ionization as described herein. The resulting plasma generates ultraviolet light that propagates through a transparent port 218 positioned adjacent to the plasma confinement region 202.

It should be understood that there are numerous performance advantages inherent in the solid state switching pulsed power system according to the present teaching that is used to drive current pulses. The system allows flexibility over traditional magnetically switched systems which are limited by eddy current and hysteresis losses in the magnetic switch core region. Importantly, frequency of current pulses can be greatly increased compared with known systems that use magnetically switched power supplies. Also, the energy per pulse can be significantly increased compared with known systems that use magnetically switched power supplies. The result of these enhancements is an increase in the production of EUV radiation and much more flexible operation.

### EQUIVALENTS

While the Applicant's teaching is described in conjunction with various embodiments, it is not intended that the Applicant's teaching be limited to such embodiments. On the contrary, the Applicant's teaching encompasses various alternatives, modifications, and equivalents, as will be appreciated by those of skill in the art, which may be made therein without departing from the spirit and scope of the teaching.

1-24. (canceled)

25. A light source comprising:
a) a chamber comprising a plasma generation region that defines a plasma confinement region;
b) a magnetic core positioned around a portion of the chamber, the magnetic core configured to generate a plasma in the plasma generation region that converges in the plasma confinement region;
c) a switched power supply having an output that is electrically connected to the chamber, the switched power supply comprising a charging circuit that generates a plurality of voltage pulses at the output causing a plurality of current pulses to be applied to a power delivery section around the magnetic core so that at least one plasma loop is established around the magnetic core that confines plasma in the plasma confinement region, thereby forming a magnetically-confined plasma; and
d) a port positioned adjacent to the plasma generation region that allows light generated by the plasma to propagate out of the light source.

26. The light source of claim 25, wherein the switched power supply comprises a charging switch and a discharging switch.

27. The light source of claim 26, wherein at least one of the charging switch and the discharging switch comprise a solid state switch.

28. The light source of claim 26, wherein at least one of the charging switch and the discharging switch comprise a field effect transistor (FET).

29. The light source of claim 26, wherein at least one of the charging switch and the discharging switch comprise a Bi Metal-Oxide-Semiconductor Field-Effect Transistor (BiMOSFET) device.

30. The light source of claim 26, wherein at least one of the charging switch and the discharging switch comprise an Insulated Gate Bipolar Transistor (IGBT).

31. The light source of claim 25, wherein the switched charging circuit is configured to provide enough charging current at the output of the switched power supply to sustain the at least one plasma loop between generation of the plurality of voltage pulses.

32. The light source of claim 25, further comprising a flux excluder positioned proximate to the magnetic core so that the at least one plasma loop flows between the flux excluder and the magnetic core during operation.

33. The light source of claim 25, wherein a portion of the chamber connected to the power supply is electrically connected to ground potential.

34. The light source of claim 25, wherein the switched charging circuit comprises a resonant charging circuit.

35. The light source of claim 25, wherein the switched charging circuit does not use resonant charging.

36. The light source of claim 34, wherein the switched resonant charging circuit comprises at least one inductor and at least one capacitor configured so that the at least one inductor increases a voltage across the at least one capacitor during operation.

37. The light source of claim 25, wherein the switched charging circuit comprises a capacitor bank comprising multiple parallel-connected capacitors.

38. The light source of claim 25, further comprising a gas feed port positioned proximate to the plasma confinement region.

39. The light source of claim 25, further comprising a vacuum pump port positioned proximate to the plasma confinement region.

40. A method of generating an inductively coupled plasma, the method comprising:
a) configuring a chamber that defines a plasma confinement region within a plasma generation region;
b) surrounding a portion of the chamber with a magnetic core configured to converge a plasma in the plasma confinement region;
c) generating a plurality of voltage pulses; and
d) applying the generated plurality of voltage pulses across a power delivery system coupled to the chamber, thereby causing a plurality of current pulses to be applied to a power delivery section around the magnetic core so that at least one plasma loop is established around the magnetic core that confines plasma in the plasma confinement region, thereby forming a magnetically confined Z-pinch plasma.

41. The method of claim 40, further comprising electrically coupling a portion of the chamber to ground potential.

42. The method of claim 40, further comprising applying a current to the power delivery section around the magnetic core that sustains the at least one plasma loop between generation of the plurality of voltage pulses.

43. The method of claim 40, wherein the current applied to the power delivery section around the magnetic core that sustains the at least one plasma loop between generation of the voltage pulses is applied at times between the plurality of voltage pulses.

44. The method of claim 40, further comprising increasing the confinement of magnetic flux in the plasma confinement region using a flux excluder positioned proximate to the magnetic core.

45. The method of claim 40, further comprising providing feed gas proximate to the plasma confinement region.

46. The method of claim 40, further comprising pumping gas proximate to the plasma confinement region.
